(19) United States
(12) Patent Application Publication
(10) Pub. No.: US 2020/0047187 A1
(43) Pub. Date: Feb. 13, 2020

(54) GRINDING-ROLLER APPARATUS

(71) Applicant: LOESCHE GmbH, Duesseldorf (DE)

(72) Inventor: Ralf BATRI, Duesseldorf (DE)

(73) Assignee: LOESCHE GmbH, Duesseldorf (DE)

(21) Appl. No.: 16/076,246

(22) PCT Filed: Feb. 8, 2016
(86) PCT No.: PCT/EP2016/052583

§ 371 Date: Aug. 7, 2018

(51) Int. Cl. B02C 15/04; B02C 15/00

(52) U.S. Cl. CPC B02C 15/04; B02C 15/004

(57) ABSTRACT

The invention relates to a grinding roller device for a roller mill having a sleeve-like mount for securing the spindle of the grinding roller, wherein the grinding roller is rotatively mounted in axial direction in a stationary way at the end region of the spindle, and wherein the sleeve-like mount features at least one clamping means in order to secure the spindle in the mount against rotation and axial movement. The invention is characterized in that the sleeve-like mount features an inner eccentric sleeve to provide for adjustability of the spindle of the grinding roller, and in that the eccentric sleeve is arranged in the sleeve-like mount to provide at least rotary adjustment of the spindle, and/or in that the eccentric sleeve is displaceably accommodated in the sleeve-like mount to provide axial displacement in axial direction of the spindle of the grinding roller.

The invention relates to a grinding roller device for a roller mill, wherein a sleeve-like mount for securing the spindle of the grinding roller is provided, and the grinding roller is mounted in a rotative yet fixed position in the axial direction at the end region of the spindle and, moreover, the sleeve-like mount features at least one clamping means in order to secure the spindle in the mount against rotation and axial movement.

Grinding roller devices of this kind are known, for example, from DE 31 00 341 A1 or WO 2005/028112 A1.

In this context, the grinding roller device according to the invention essentially relates to the sleeve-like mount in which the spindle of the grinding roller is secured torque proof by way of a clamping means as well as the grinding roller itself, which has a base body and a grinding roller shell and is normally mounted as a unit able to rotate at the end of the spindle projecting into the roller mill.

Roller mills of the kind being referred to typically feature at least two grinding roller devices, whereas larger roller mills are designed to have already six grinding roller devices. Roller mills and grinding rollers of this kind are used in particular for the comminution of clinker material, foundry sand, limestone, and similar materials in order to produce a fine-grained as end product from said materials having the desired particle size.

Given that one significant factor in the process for grinding the aforementioned or similar materials is the corresponding milling gap between the grinding table of a roller mill and the grinding surface of the grinding roller or rather the roller shell thereof that rolls upon the mill feed, producers of grinding roller devices and roller mills of this kind are striving to make this milling gap easily adjustable at least in a vertical direction in order to achieve optimal efficiency for the roller mill with a view to producing the fine material desired.

Also, in this context, manufacturers and operators of roller mills of this kind must always take the wear and material abrasion of the grinding surfaces of the roller shell rolling upon the mill feed into consideration, so they endeavor to compensate for material abrasion from the rolling surface of the roller shell as quickly as possible.

Previously, this took place by means of welding onto or armoring the grinding surfaces that are prone to wear. This is typically performed directly in the milling space during roller mill downtime and when the roller mill temperature has cooled down.

In addition, a further factor relevant to an optimal grinding process is evident from the production tolerances of the grinding roller device having a spindle and a grinding roller and the arrangement thereof with respect to the grinding table. For this reason, it is also desirable for the grinding roller to be easily adjustable in an axial direction, for example with respect to the distance from the edge of the grinding table.

Therefore, the object of the invention is to overcome the aforementioned disadvantages of a roller mill having grinding roller devices of this kind, and, given relatively short downtimes of the roller mill, to compensate for the effects of wear, in particular the roller shell, as well as to simplify and make more economical the design for adjustability of the grinding rollers in a vertical direction with respect to the milling gap and, optionally, also with respect to the radial distance to the edge of the grinding table with a view to an efficient grinding process.

According to the invention, this object will be achieved using the aforementioned grinding roller device of said type and by means of the features of the characterizing portion of claim 1, whereby the sleeve-like mount features an inner eccentric sleeve for adjustability of the spindle of the grinding roller, and the eccentric sleeve is arranged in the sleeve-like mount to provide at least rotary adjustment of the spindle, whereby, optionally and alternatively, the eccentric sleeve is accommodated in the sleeve-like mount to provide for axial displacement of the spindle of the grinding roller in the direction of the spindle.

Therefore, a central idea of the invention is to abandon the previous used arrangement in which the spindle of the grinding roller was secured in a central bearing directly in the sleeve-like mount or rather the lever, and to instead shift it into a displaceable eccentric sleeve such that a vertical adjustment of the grinding surface of the grinding roller with respect to the grinding table by, for example, 20° to as far as 90° or 180° is possible by means of rotating or rather a turning the eccentric sleeve in the lever.

A further central idea of the invention is evident from the accomplishment of axial displacement of the eccentric sleeve in the sleeve-like mount in the lever such that also the radial distance between the grinding roller and the edge of the grinding table is adjustable, and thus accomplishing an axial or rather a nearly horizontal adjustment of the grinding surface of the grinding roller.

The prerequisite for said adjustment options is the eccentric sleeve in the sleeve-like mount, which interacts with a clamping means that is designed to secure the spindle in the eccentric sleeve torque proof and axial movement.

The aforementioned terms regarding the vertical adjustment or the horizontal adjustment of the grinding roller are in one respect based on the grinding surface of the grinding roller. Primarily being referred to in this context are grinding rollers designed to have a frustoconical shape, the grinding surfaces of which are either vertically somewhat elevated or somewhat lowered or honizontally are somewhat displaced with respect to a horizontally-oriented grinding bed of a grinding table.

Given that, in grinding rollers having a frustoconical shape in particular, adjustment of the spindle of the grinding roller always takes place with the spindle at an incline, adjustment can also be referred to as being either “perpendicular,” or rather nearly vertical to the spindle or “axial,” or rather nearly horizontal to the spindle.

For the sake of simplicity, the term “vertical adjustment” or “horizontal adjustment” of the grinding roller will be chosen, in which context the focus of these descriptions is on the adjustability of grinding rollers having a frustoconical shape with respect to a horizontally-oriented grinding bed on a grinding table.

Advantageously, the design principle providing the adjustability of the spindle of the grinding roller in a vertical direction and/or in an axial direction is designed that stepless adjustment is possible. As modification thereof, the design can also have step-wise adjustment options.

The grinding roller device is suitable for a wide variety of grinding roller shapes. The grinding rollers can thus be cylindrical, ball-like, or conical, or frustoconical, in shape.

Therefore, given its adjustability, the grinding roller device can advantageously be used for both horizontally-oriented grinding roller spindles and for spindles having an inclined orientation, which is typical of grinding rollers (or rather the roller shells thereof) having a frustoconical shape.

A quite significant advantage of the grinding roller device according to the invention consists of both the vertical adjustability of the spindle and grinding roller and the axial adjustability thereof being able to be performed externally, hence from the exterior of the normally sealed housing of a roller mill.

As a result, the design and arrangement according to the invention makes adjustment of a corresponding grinding roller possible within relatively short periods of time, approximately four hours, without affecting the sealing of the housing of corresponding roller mill. Another result of this relatively short adjustment period is that, due to the relatively short roller mill downtime, extensive cooling of the roller mill is avoided, as a result of which the energy demand for starting up and reaching the operating temperature of the roller mill is significantly reduced.

As a result, the grinding roller device according to the invention can with relatively little structural complexity surpass previous measures for precise positioning of the grinding roller with respect to the grinding table, for example those that required modifying the bearing of the grinding roller and/or welding material onto the roller shell or extending the roller spindle itself.

In addition, the solution used by the invention follows the approach of providing the adjusting means used for vertical and/or axial adjustment as close as possible to the assemblies being adjusted, e.g. the spindle and the grinding roller, in order to keep as small as possible the shifting and movement of assembly weight and to achieve only small distances to the areas being adjusted, for example the milling gap, thereby improving the precision of the adjustment.

According to the invention, disadvantages of possible eccentric bearings positioned farther away from the grinding roller devices are also overcome in this manner.

The invention is particularly suitable for use in roller mills of modular construction as previously described in WO 2005/028112 A1.

Advantageously, the eccentric sleeve is designed to have an eccentric wall thickness across an angular area of the sleeve wall measuring less than 180°, in particular from approximately 90° to 120°. As a result, the eccentric wall thickness of the sleeve continuously increases going from the base circle of the eccentricity such that the eccentric sleeve reaches a maximum wall thickness at a horizontal section through the spindle at approximately 90° or 270°.

As a result, the arrangement of the eccentric wall thickness of the sleeve at approximately 90° or 270°, hence in a direction perpendicular to the spindle of the grinding roller, makes it possible for the eccentric sleeve and, therefore, the spindle along with the grinding roller, to be adjusted “vertically” so to speak to the smallest milling gap distance, given a rotary adjustment of 90° upwards.

In contrast, rotation of the maximum eccentric wall thickness downwards into a 180° orientation enables vertical displacement of the spindle and the grinding roller as far as the largest possible milling gap distance.

It is therefore preferable to provide the eccentric wall thickness of the sleeve in approximately the 90° or 270° area of the spindle and to arrange at least the area of the spindle in the direction of 0° or 180° to be rotatable.

By designing the grinding roller device to have a maximum eccentric wall thickness in the 90° area, a vertical section of the eccentric sleeve in this normal position would feature wall thicknesses in the 0° area and the 180° area which are designed to be largely equal in strength, meaning that they are at approximately the same radial distance from the longitudinal axis of the spindle of the grinding roller.

In order to enable axial displacement of the spindle of the grinding roller, the sleeve-like mount features axially displaceable engagement with the eccentric sleeve.

Advantageously, the axially displaceable engagement is realized via an engaging element, which is externally actuated by means of an actuating element and has an engaging region between two of the rings that extend around the eccentric sleeve.

Further simplification is accomplished by arranging the engaging element to be eccentric to the longitudinal axis of the actuating element, which faces in a direction radial to the longitudinal axis of the sleeve, in which context the actuating element is designed in particular as a rotary actuating element, and thus making axial adjustability of the spindle of the grinding roller possible by way of slight rotary movements.

Vertical adjustment of the spindle and the grinding roller is made in the direction of rotation by means of rotary adjustment of the inner eccentric sleeve, to which the spindle is axially and rotativly secured by way of a clamping means. For this purpose, provided opposite of the grinding roller on the end side in the area of the spindle is an adjusting means, which advantageously features a sector gear region on an outer annular flange of the eccentric sleeve such that said sector gear region is rotatable via a gear, for example one acting as an adjusting pinion. By this means, the maximum wall thickness of the eccentric sleeve can be rotated, for example from the 90° area to the 0° area, in such a manner that, in this case, vertical lowering of the grinding roller with respect to the grinding table of a roller mill is accomplished.

As a result, the annular flange has a rigid connection with the eccentric sleeve, so that the rotary movement is also transferred to the spindle and therefore to the grinding roller.

In a further advantageous embodiment, it is provided that the outer circumference of the eccentric sleeve features an annular region having two circumferential rings which are adapted in a radial direction to the eccentric wall thickness of the eccentric sleeve, and that, advantageously, a positively locking engagement area is formed between the rings for the axially displaceable engagement.

In the exemplary embodiments of the invention, the normal position of the grinding roller is considered to be a configuration in which the maximal eccentric wall thickness will lie in the 90° area, with the 0° area and the 180° area of the eccentric sleeve featuring approximately the same radial wall thicknesses, which is also applicable to the circumferential rings.

Regarding this aspect, the central longitudinal axis of the eccentric sleeve in the normal position is slightly offset in the direction of the eccentric wall thickness of the eccentric sleeve with respect to the central longitudinal axis of the spindle of the grinding roller. In terms of structure, depending on the size of the grinding roller device and the mill feed being ground, this offset can be a shift measuring, for example, 25 mm, or even 15 mm to 35 mm.

Accordingly, the spindle and the grinding roller can be adjusted in a vertical direction by this offset.

The invention is suitable for a variety of grinding roller outer contours, for example frustoconical-, cylindrical-, or ball-shaped outer contours. In terms of purpose, the invention can be used in an advantageous and straightforward manner for roller mills in which the sleeve-like mount forms a lever for the spindle and the grinding roller, in which case the top side of the lever is rigidly fixed by the fork members of a fork, and the fork is pivotable by means of an actuable swing lever around the swing lever axis thereof.

This design principle is accomplished primarily in the modular construction used in roller mills.

The grinding roller device being claimed is particularly suitable for a roller mill having a rotatable grinding table, upon which at least one grinding roller is provided that rolls upon in frictional engagement with the mill feed being comminuted. In this context, by means of the adjustability of the eccentric sleeve, both the radial distance between the grinding roller and the edge area of the grinding table and/or the distance between the rolling surface of the grinding roller and the grinding table can be adjusted with a view to optimizing the comminution of the mill feed.

Particularly regarding mills in which a variety of mill feeds are intended to be comminuted, the adjustability of the grinding roller device also offers, by means of said adjustability, the advantage of being able to adjust the optimal position for the mill feed being comminuted between the grinding rollers and the grinding table in a relatively short period of time. Said adjustability also enables the spindle of the grinding roller to compensate in both directions for the wear on the grinding bed of the grinding table with a view to optimizing the milling gap.

Moreover, regarding wear on the retaining edge, the nearly horizontal adjustability of the grinding roller enables the distance between the inner retaining edge being affected by wear and the outer edge of the grinding roller to be kept essentially constant since material abrasion from the inner retaining edge can essentially be compensated for by means of retracting the grinding roller or displacing it radially outward.

The invention will be illustratively and schematically explained in even greater detail hereinafter with the aid of a number of drawings. Being shown are:

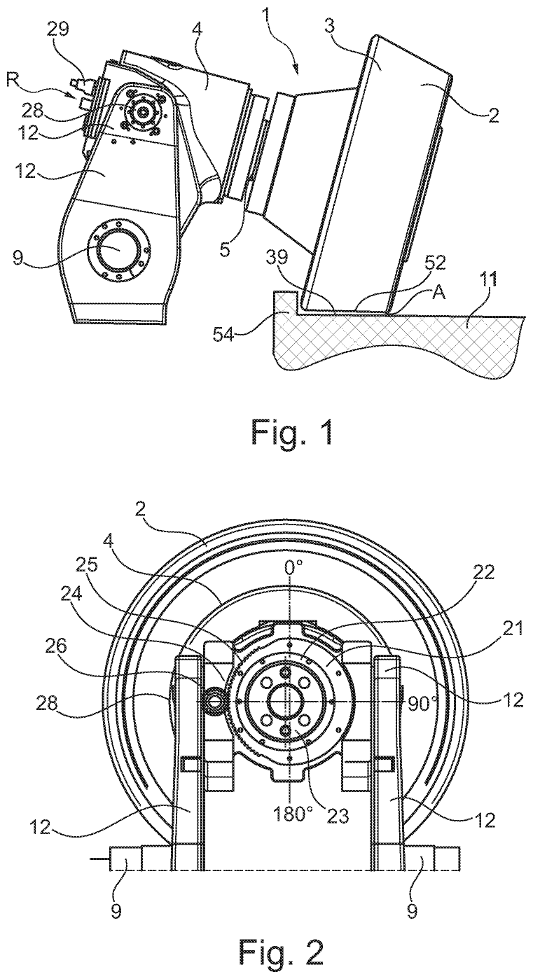

FIG. 1 a schematic side view of a grinding roller device and how it can be mounted in a fork of a swing lever in a roller mill and operably arranged with respect to a grinding table of a corresponding roller mill;

FIG. 2 a rear view of the example according to FIG. 1 with the significant assemblies used for rotary adjustability of the spindle and, therefore, vertical adjustability of the grinding roller;

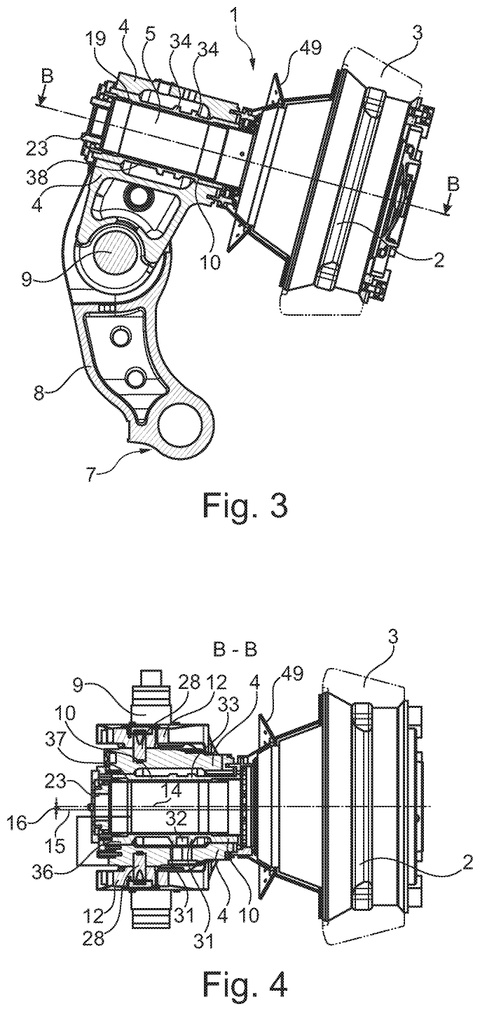

FIG. 3 a partly vertical section of a comparable example of a further grinding roller device having a downward-projecting swing lever and the swing lever axis thereof along with a central longitudinal axis for the spindle and the grinding roller;

FIG. 4 a section along the line B-B according to FIG. 3, which will be referred to as a horizontal section, with the eccentric sleeve arranged in its normal position and the maximum eccentric wall thickness in a 90° area (downwards in FIG. 4), with the slight offset of the central longitudinal axis of the eccentric sleeve and the grinding roller being indicated.

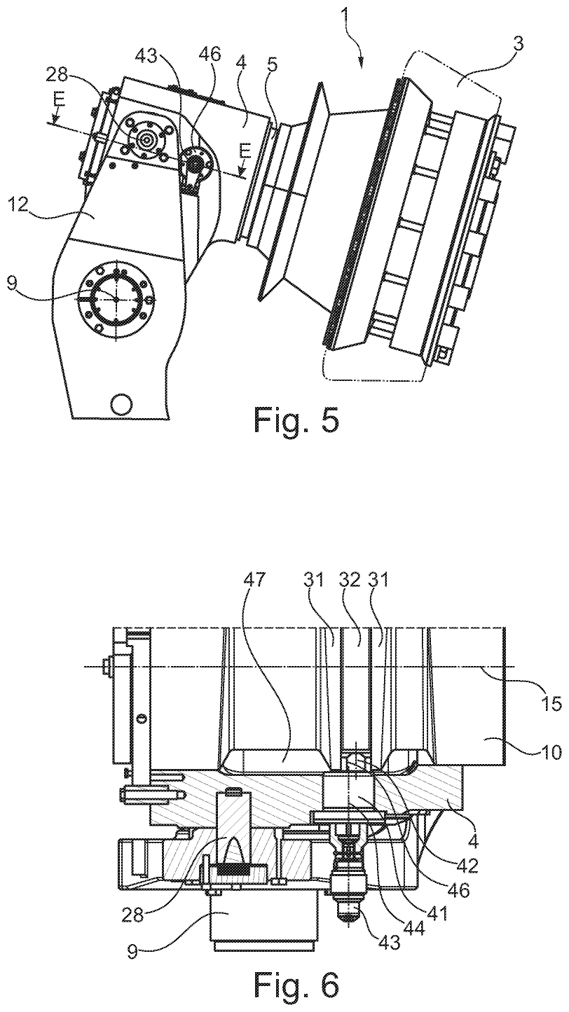

FIG. 5 a side view of a grinding roller device similar to that shown in FIG. 1, and

FIG. 6 a schematic section along the line E-E through the corresponding lever according to FIG. 5 along with the schematic arrangement of the corresponding assemblies used for axial adjustability of the spindle and the grinding roller.

The drawings in this application relate to slightly revised exemplarity embodiments of the grinding roller device, in which context their arrangement and their connection to further assemblies of a roller mill is also schematically depicted.

Use of the same reference signs relates to the same assemblies, although small deviations in the assemblies may exist. In addition, the views and sections of the grinding roller device shown in the drawings will be brought into a relationship with one another even though various scales are being shown.

FIG. 1 shows a side view of the schematic arrangement of a grinding roller device 1 with respect to the rigid securing thereof in the fork side members 12 of a fork 8 of a swing lever 7 (FIG. 3), with the working position of a grinding roller 2 being illustrated with respect to a grinding table 11 of a roller mill at the same time.

The left side of the grinding roller device 1 features a sleeve-like lever 4, which is rigidly secured via a securing means 28 at the end region of the fork side members 12 of the fork 8. The interior of lever 4 accommodates an eccentric sleeve 10 (FIGS. 3 and 4). The spindle 5 of the grinding roller device 1 is secured in this eccentric sleeve 10 against rotation and axial movement by way of a clamping means 19 (FIG. 3).

As a result, the spindle 5 is at least frictionally accommodated in the eccentric sleeve 10 and secured such that rotation of or slight axial displacement of the spindle 5 is only able to take place by means of a corresponding operation for moving the eccentric sleeve 10.

The grinding roller 2 in the example according to FIG. 1 is equipped with a frustoconical or rather a conical roller shell 3 (FIG. 3). By virtue of this configuration, the longitudinal axis of the grinding roller device 1 is inclined in the direction of the horizontally-oriented grinding table 11 by an angle of, for example, 10° to 30°.

Insofar as the grinding roller device 1 were to feature a cylindrical grinding roller instead of a conical grinding roller 2, the longitudinal central axis of the grinding roller device would in principle be horizontal and would not be inclined in the direction of the grinding table. The arrangement could also take place in a similar fashion using a ball-shaped grinding roller.

FIG. 2 illustrates the embodiment shown in FIG. 1 and the significant assemblies thereof, using a schematic view of the rear in the direction of the arrow R. In one respect, the lever 4 is secured via the securing means 28 in the fork side members 12 of the fork 8 (FIG. 3). In a second respect, the view of the rear of the grinding roller device 1 shows an annular flange 21 for the eccentric sleeve 10. Illustrated radially inward is a requisite clamping ring 22, in which context the rear closure of the sleeve 4 can be realized using a bayonet closure 23.

As shown in FIG. 2, an adjusting means 24 is present, which essentially consists of a sector gear 25 of the annular flange 21. In the example, said sector gear 25, which is provided across an angular range of approximately 90° to 120°, is in tooth-type rotary engagement with an adjusting pinion 26 having a significantly smaller radius.

FIG. 2, which is a view in the direction of the longitudinal axis 14 (FIG. 4), indicates angular values of 0°, 90°, and 180° for the spindle 5 (FIG. 3) and the roller 2 (FIG. 4). Reference thereto will still be made hereinafter with respect to the eccentric wall thickness of the sleeve 10.

In FIG. 3, a schematic vertical section through the grinding roller device 1 illustrates the internal structure and the arrangement of the spindle 5 with the eccentric sleeve 10 within the lever 4. The section along the line B-B (FIG. 3), which is illustrated in FIG. 4, is included at the same time for reference in order to clarify the eccentric sleeve 10.

As shown in FIG. 3, the sleeve 4 is rigidly connected to the upper ends of the fork side members 12 of the fork 8 via the securing means 28 (FIG. 1). During operation of a roller mill equipped with a grinding roller device 1 of this kind, the requisite grinding force is applied to the rolling surface 52 of the grinding roller 2 via a swing lever 7 which is pivotable around its swing lever axis 9 and which, in the example, relates to the combination of the fork 8, the fork side members 12, and the lever 4 as well as the grinding roller device 1 attached thereto, in which context opposing forces from the mill feed being comminuted may act on the swing lever 7.

The eccentric sleeve 10 is at least rotatably accommodated in the interior of the lever 4 via an angular range as well as being accommodated in an axially displaceable manner. Via the clamping means 19, the eccentric sleeve 10 itself is rigidly connected against rotation and axial movement to the spindle 5 of the grinding roller device 1.

The section shown in FIG. 3 shows, in principle, the “normal position” of the grinding roller device 1, whereby the roller milling gap 39 (FIG. 1) between the grinding roller 2 and the grinding table 11 is adjusted to a distance A at the beginning of operation.

Given that wear of the rolling surface 52 of the roller shell 3 occurs during the process of comminuting the relevant materials such as clinker, and that abrasion of the substance of the roller material results thereby, the outcome is an undesirable enlargement of the distance A of the milling gap 39. Previously, this problem was remedied by welding material onto the roller or by appropriately armoring the rolling surface 52.

However, this measure required downtime for the roller mill, which led to cooling of the roller mill, in order for the measures to be carried out directly in the milling space.

According to the invention, altering the distance A of the milling gap 39 can now be carried out from outside the roller mill housing, without having to affect the sealing of the roller mill housing. The largely gastight seal between the grinding roller device 1 and the roller mill housing itself is provided in the approximate area of the circumferential annular orifice 49 (FIG. 3) such that adjustment of the grinding roller 2 is able to be carried out in a nearly vertical or in a nearly horizontal, i.e. axial, direction from outside of the roller mill housing.

While FIG. 3 shows a section of the arrangement of the grinding roller along the line from 0° to 180° (FIG. 2), the section according to FIG. 4 shows the internal arrangement of the eccentric sleeve 10 within the lever 4 in the 90° area (FIG. 2).

In the illustration shown in FIG. 3, the eccentric sleeve 10 features wall thicknesses 38 which are largely equal both in the upper area (0° area) and in the lower area (180° area). The outer circumference of the sleeve 10 has two axially spaced rings 34, between which a groove-like engagement area 32 is formed.

The schematic illustration shown in FIG. 4 of the grinding roller device 1 shown in FIG. 3 shows the eccentric sleeve 10 with the wall thickness 36 thereof in the 90° area (FIG. 2). In the lower area shown in FIG. 4, which corresponds to the eccentric thickening of the wall region, two rings 31 radially protruding are provided from the sleeve 10, with an engagement area 2 being provided between them.

In addition, by virtue of the greater wall thickness 36 in the lower area (90° area) of the eccentric sleeve 10, the longitudinal axis 15 of the sleeve 10 is offset (16) with respect to the longitudinal axis 14 of the spindle 5 and the grinding roller 2.

Insofar as wear on the roller shell 3 makes it necessary to readjust the grinding roller 2 in order to optimize the distance A of the milling gap 39, the adjusting means 24 (FIG. 2) can then be actuated according to the invention in order to return the increased distance A of the milling gap 39 to the normal distance desired. As shown in FIGS. 2 and 4, the eccentric sleeve 10 having the increased wall thickness 36 in the 90° area is for this purpose turned upwards in a rotary manner (FIG. 2) until approximately the 0° area.

A nearly vertical downward displacement of the grinding roller 2 and the rolling surface 52 thereof is accomplished in this manner such that the milling gap 39 is able to be adjusted to its normal distance even following heavy material abrasion.

Although the eccentric sleeve 10 is turned together with the spindle 5 in a rotary manner via the adjusting means 24, which features an actuating means 29 (FIG. 1), the result is a nearly vertical displacement of the grinding roller 2.

FIG. 5 shows a grinding roller device 1 having a design similar to that shown in FIG. 1.

The lever 4 in this case is rigidly connected to the fork side members 12 of the fork 8 and the swing lever thereof via the securing means 28. At the level of the section line E-E, which also corresponds to the longitudinal axis 15 of the eccentric sleeve 10, an axial displacing means 46 is present along with an adjustment tool 43 as indicated.

The schematic section shown in FIG. 6 along the line E-E shown in FIG. 5 is illustrated with respect to the lever 4 and the eccentric sleeve 10 only as a partial section and essentially symmetrical to the longitudinal axis 15.

The sleeve 10 in this case is accommodated to be rotatively and axially adjustable within the lever 4 using two spaced circumferential rings 31 with a groove formed between them acting as an engagement area 32. In this context, the sleeve 10 is rigidly connected to the spindle 5 via a clamping means. A circumferential outer recess 47, which simplifies the axial relocatability of the sleeve 10, is provided on both sides of each of the rings 31.

In the example shown in FIG. 6, the axial adjusting means 46 features an adjustment cylinder 41, eccentric to the longitudinal axis 44 of which is an engaging pin 42, which projects into the groove of the engagement area 32.

By means of an outwardly attached adjustment tool 43, for example, it is possible via rotary movement of the adjustment tool 43 to actuate the eccentrically arranged engaging pin 42, thus accomplishing axial displacement of the eccentric sleeve 10.

The corresponding axial displacement distance can in this case be relatively small, for example in the range of up to 10 cm. By virtue of this axial displacement of the eccentric sleeve 10, the spindle 5 and the grinding roller 2 rotatably arranged at the end thereof are also axially displaced. As a result, the grinding roller 2 as shown in FIG. 1 can in this manner be displaced toward the right of the grinding table 11, thus being displaced further inward in a radial direction. Displacement in the opposite direction is of course also possible.

Consequently, the grinding roller device according to the invention makes it possible for the grinding roller to be adjustable in a nearly vertical and in a nearly axial direction from outside of the housing of a corresponding roller mill, thereby allowing the repair periods used for remedying the wear of material from the roller shell to be relatively short as well as accomplishing optimal adjustment with a view to both a normal milling gap and to the radial placement of the grinding roller with respect to the grinding table.

1.-12. (canceled)

13. A grinding roller device for a roller mill comprising:
a sleeve-like mount for securing a spindle of the grinding roller,
wherein the grinding roller is rotatively mounted in axial direction of the spindle in a fixed way at an end region of the spindle, and
wherein at least one clamping means is provided in the sleeve-like mount to rotationally secure and axially secure the spindle,
wherein:
the sleeve-like mount comprises an inner eccentric sleeve to provide for adjustability of the spindle of the grinding roller, and
one or more of the following:
by rotation of the inner eccentric sleeve, the longitudinal axis of the spindle is variable within the sleeve-like mount, and
the eccentric sleeve is displaceably accommodated in the sleeve-like mount to provide axial displacement of the spindle of the grinding roller in the direction of the spindle.

14. The grinding roller device according to claim 13, wherein the eccentric sleeve has an eccentric wall thickness across an angular area of the sleeve wall measuring less than 180°.

15. The grinding roller device according to claim 14, wherein the angular area of the sleeve wall is within a range of 90° to 120°.

16. The grinding roller device according to claim 13, wherein the eccentric wall thickness of the sleeve is provided in a 90° area of the spindle, and is provided to be rotatable at least in the spindle in the direction of the 0° area or a 180° area.

17. The grinding roller device according to claim 13, wherein a vertical section of the eccentric sleeve in normal operation features wall thicknesses in the 0° area and the 180° area which are designed to be equal in strength.

18. The grinding roller device according to claim 13, wherein for the purpose of axial displacement of the spindle of the grinding roller, the sleeve-like mount has axially displaceable engagement with the eccentric sleeve.

19. The grinding roller device according to claim 13, wherein for the purpose of rotary adjustment of the spindle, the end side of the inner eccentric sleeve opposite the grinding roller has an adjusting means comprising a sector gear region on an annular flange of the eccentric sleeve which is rotatively actuable using an adjusting pinion.

20. The grinding roller device according to claim 19, wherein:
the outer circumference of the eccentric sleeve comprises an annular region comprising two circumferential rings which are adapted in a radial direction to the eccentric wall thickness of the eccentric sleeve, and
a positively locking engagement area is formed between the rings for the axially displaceable engagement.

21. The grinding roller device according to claim 20, wherein:
the axially displaceable engagement comprises an engaging element that is externally actuable with the engaging area of the rings by means of an actuating element, and
the engaging element is arranged eccentrically to the longitudinal axis of the actuating element configured as a rotary actuating element.

22. The grinding roller device according to claim 13, wherein the central longitudinal axis of the eccentric sleeve in the normal position of the grinding roller is offset in the direction of the eccentric wall thickness of the eccentric sleeve with respect to the central longitudinal axis of the spindle of the grinding roller.

23. The grinding roller device according to claim 13, wherein:
the roller mill has a cylindrical, ball-shaped or frustoconical outer contour of the grinding roller, and
the sleeve-like mount forms a lever for the spindle and the grinding roller which is rigidly fixed by a fork at a top side of an actuable swing lever, and said swing lever is pivotable around the swing lever axis thereof.

24. The grinding roller device according to claim 13, wherein:
the roller mill has a rotatable grinding table, and at least one grinding roller rolling upon in frictional engagement with the mill feed being comminuted, and
the radial distance between the grinding roller and the edge area of the grinding table and/or the distance between the rolling surface of the grinding roller and the grinding table is adjustable by means of the adjustability of the eccentric sleeve.
